(19) United States
(12) Patent Application Publication
(10) Pub. No.: US 2025/0327460 A1
(43) Pub. Date: Oct. 23, 2025

(54) BLOWER

(71) Applicant: JIANGSU DONGCHENG M&E TOOLS CO., LTD., NANTONG (CN)

(72) Inventor: CHENGLI LIU, NANTONG (CN)

(21) Appl. No.: 19/251,885

(22) Filed: Jun. 27, 2025

Related U.S. Application Data
(63) Continuation of application No. PCT/CN2024/102301, filed on Jun. 28, 2024.

(30) Foreign Application Priority Data
Aug. 30, 2023 (CN) 202311107824.4

(51) Int. Cl. F04D 25/06; A01G 20/47

(52) U.S. Cl. CPC F04D 25/0673; A01G 20/47

(57) ABSTRACT

A blower includes a housing extending along an axial direction, a battery pack detachably connected to the housing, a drive assembly at least partially housed within the housing, and a blow pipe assembly connected to the housing. The housing includes a connection portion connected to the blow pipe assembly, a main body portion connected to a rear end of the connection portion, and a mounting portion connected to the main body portion. The main body portion includes an air inlet fluidly communicated with the external environment along the axial direction and a pre-intake region located axially behind the air inlet. Provision of an air inlet opening axially rearward and a pre-intake region located axially behind the air inlet can improve the air intake efficiency.

### CROSS REFERENCE TO RELATED APPLICATIONS

The present application is a continuation of PCT patent application No. PCT/CN2024/102301, entitled “BLOWER”, filed on Jun. 28, 2024, which claims priority to Chinese patent application No. CN202311107824.4, entitled “BLOWER,” filed on Aug. 30, 2023, each of which is incorporated by reference herein in its entirety.

### TECHNICAL FIELD

The present disclosure relates to a blower.

### BACKGROUND

A blower is a commonly used gardening tool, including a housing, a blow pipe connected to the housing, a duct housed within the housing, a motor arranged in the duct, and a fan driven by the motor. During operation, the fan rotates to generate negative pressure within the housing, drawing external air into the housing through an air inlet of the housing and expelling the air out through an air outlet of the blow pipe, thereby blowing leaves or dust to specific locations. In existing technologies, to prevent dust or the like from entering the housing due to the negative pressure, a detachable inlet cover with a grille is typically installed at the air inlet. This increases the number of components, and also increases the number of steps of the assembly process, leading to higher material and assembly costs.

In view of this, there is a need to provide an improved blower to overcome the disadvantages of the prior art.

### SUMMARY

To overcome the disadvantages of the prior art, an objective of the present disclosure is to provide a blower.

The technical solution adopted by the present disclosure is as follows. A blower includes a housing extending along an axial direction, a battery pack detachably connected to the housing, a drive assembly at least partially housed within the housing, and a blow pipe assembly connected to the housing. The housing includes a connection portion connected to the blow pipe assembly, a main body portion connected to a rear end of the connection portion, and a mounting portion connected to the main body portion. The drive assembly includes a motor and a fan driven by the motor to generate airflow flowing through the blow pipe assembly. The main body portion includes an air inlet and a pre-intake region located axially behind the air inlet. The pre-intake region is located on two sides of the mounting portion in a transverse direction perpendicular to the axial direction.

In some embodiments, the air inlet and the pre-intake region are axially located between the mounting portion and the connection portion.

In some embodiments, the main body portion includes a bearing wall located at the rear end thereof and connected to the mounting portion, where the air inlet opens axially rearward, and an axial spacing between the bearing wall and the air inlet forms the pre-intake region.

In some embodiments, the axially rear end of the main body portion is provided with a bearing wall connected to the mounting portion, where an axial spacing between the bearing wall and the air inlet forms the pre-intake region.

In some embodiments, the main body portion includes an expansion wall connecting the connection portion to the air inlet and an extension wall connecting the air inlet to the bearing wall, where a transverse dimension of the expansion wall is larger than that of the extension wall, the air inlet is arranged on a protruding region of the expansion wall that protrudes transversely from the extension wall, and the extension wall extends axially forward from the bearing wall and is recessed transversely inward to form the pre-intake region.

In some embodiments, the expansion wall and the extension wall are of a substantially closed structure in the transverse direction.

In some embodiments, the blower includes multiple flow guide portions spaced apart at the air inlet, where an extension direction of the flow guide portions is substantially parallel to an insertion/removal direction of the battery pack.

In some embodiments, the flow guide portions are integrally formed with the main body portion.

In some embodiments, a ratio of the maximum transverse dimension of the air inlet to the maximum transverse dimension of the main body portion is greater than or equal to 0.1.

In some embodiments, the housing includes a handle portion connecting the main body portion to the mounting portion, where the bearing wall connected to the mounting portion is provided at the axially rear end of the main body portion, and includes a first sidewall facing the handle portion and a second sidewall facing the battery pack, where the first sidewall and the second sidewall are located on opposite sides of the mounting portion in a vertical direction perpendicular to the axial direction and the transverse direction.

In some embodiments, a projection of the air inlet along the vertical direction at least partially overlaps with a projection of the handle portion along the vertical direction, and a projection of the air inlet along the axial direction at least partially overlaps with a projection of the battery pack along the axial direction.

### BRIEF DESCRIPTION OF THE DRAWINGS

FIG. 1 is a schematic perspective view of a blower according to a preferred embodiment of the present disclosure;

FIG. 2 is a front view of the blower in FIG. 1 with a blow pipe removed;

FIG. 3 is a bottom view of the blower in FIG. 2;

FIG. 4 is a right-side view of the blower in FIG. 1;

FIG. 5 is a partially exploded view of the blower in FIG. 2; and

FIG. 6 is a cross-sectional view of the blower in FIG. 2.

### DETAILED DESCRIPTION OF THE EMBODIMENTS

The present disclosure is further described in detail below in combination with the accompanying drawings and embodiments.

The terms used in the present disclosure are only for the purpose of describing specific embodiments and are not intended to limit the present disclosure. For example, the terms, such as “upper”, “lower”, “front”, and “rear”, indicate the orientation or positional relationship based on the orientation or positional relationship shown in the accompanying drawings. This is solely for the purpose of facilitating the description of the present disclosure and simplifying the description, and in no way indicate or imply that the devices or elements referred to must have a specific orientation, be constructed or operated in a specific orientation. Therefore, these terms should not be understood as a limitation on the present disclosure.

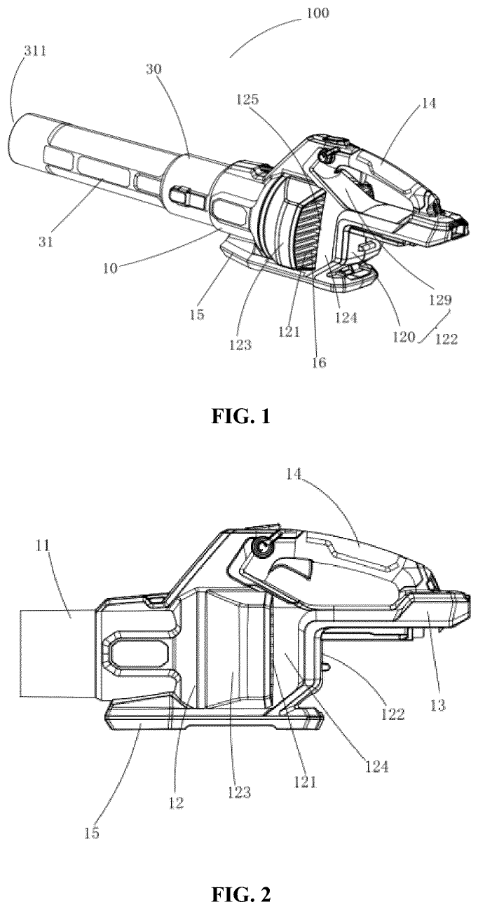

Referring to FIGS. 1 to 6, an embodiment of the present disclosure relates to a blower 100, which includes a housing 10 extending in an axial direction, a drive assembly 20 at least partially housed within the housing 10, a blow pipe assembly 30 connected to an axially front end of the housing 10, and a battery pack (not shown) connected to an axially rear end of the housing 10.

The housing 10 includes a connection portion 11 connected to the blow pipe assembly 30, a main body portion 12 connected to an axially rear side of the connection portion 11, and a mounting portion 13 for connecting the battery pack and the main body portion 12. The battery pack is detachably connected to the mounting portion 13 along the axial direction. In the axial direction, the connection portion 11, the main body portion 12, and the mounting portion 13 are arranged in sequence. The housing 10 includes a handle portion 14 one end of which is connected to the top of the main body portion 12 and the other end of which is connected to the top of the mounting portion 13. The handle portion 14 extends upward and is spaced apart from the main body portion 12 and the mounting portion 13 by a certain amount of space to form a holding space for a user to hold.

The blow pipe assembly 30 includes a blow pipe 31 detachably connected to the connection portion 11 and an air inlet pipe 32 at least partially housed within the housing 10. The blow pipe 31 and the air inlet pipe 32 jointly form a passage through which air flows. The air inlet pipe 32 includes an outer casing 321 fixed inside the housing 10, and the drive assembly 20 is at least partially housed in the outer casing 321. The drive assembly 20 includes a motor 21 having a drive shaft 211 and a fan 22 driven to rotate by the motor 21. The fan 22 rotates to generate airflow flowing through the passage of the blow pipe assembly 30.

The drive assembly 20 further includes a motor casing 23 housing at least part of the motor 21, and a flow guide cone 24 connected to the axially front end of the motor casing 23. The motor 21 is housed in the internal space formed by the motor casing 23 and the flow guide cone 24. The flow guide cone 24 is configured as a conical structure that gradually inclines towards the drive shaft 211 from rear to front. The drive shaft 211 extends axially rearward out of the motor casing 23. The fan 22 includes a hub 221 fixed to the drive shaft 211 extending out of the motor casing 23, and multiple fan blades 222 extending into the passage from the outer circumference of the hub 221. A substantially annular airflow passage is formed between the motor casing 23 and the outer casing 321 of the air inlet pipe 32. The blower 100 further includes multiple stationary guide blades 322 connected between the outer casing 321 and the motor casing 23. In the direction of airflow, the stationary guide blades 322 are located downstream from the fan blades 222.

Referring to FIGS. 1 and 2, the housing 10 includes a support portion 15 located at the bottom of the main body portion 12 to support the entire machine. In the axial direction, the extension length of the support portion 15 substantially covers the entire axial length of the main body portion 12. In the vertical direction perpendicular to the axial direction, the handle portion 14 and the support portion 15 are located on opposite sides of the main body portion 12, respectively. The mounting portion 13 extends substantially in the axial direction, and the battery pack is slidingly mounted thereto along the axial direction to provide power to the drive assembly 20.

The main body portion 12 includes an air inlet 121 that opens axially rearward, and the blow pipe 31 includes an air outlet 311 located at the axially front end. The air inlet 121 opens axially rearward, that is, it is fluidly communicated with the outside in the axial direction. As shown in FIG. 6, when the blower 100 is running, the drive shaft 211 rotates to drive the blades 222 to rotate and generate negative pressure in the passage. External air enters the passage of the air inlet pipe 32 under the action of air pressure, and after accelerated by the rotation of the blades 222, it is combed by the stationary guide blades 322 to become an airflow that is substantially parallel to the axial direction. Then, it is guided by the flow guide cone 24 into the blow pipe 31 and blown out through the air outlet 311. In the axial direction, the blow pipe 31, the air inlet pipe 32, and the mounting portion 13 are substantially aligned, so that the airflow retains its flow direction substantially unchanged after entering the housing 10, and at least some of the airflow passes through the battery pack before entering the housing 10 to cool the battery pack.

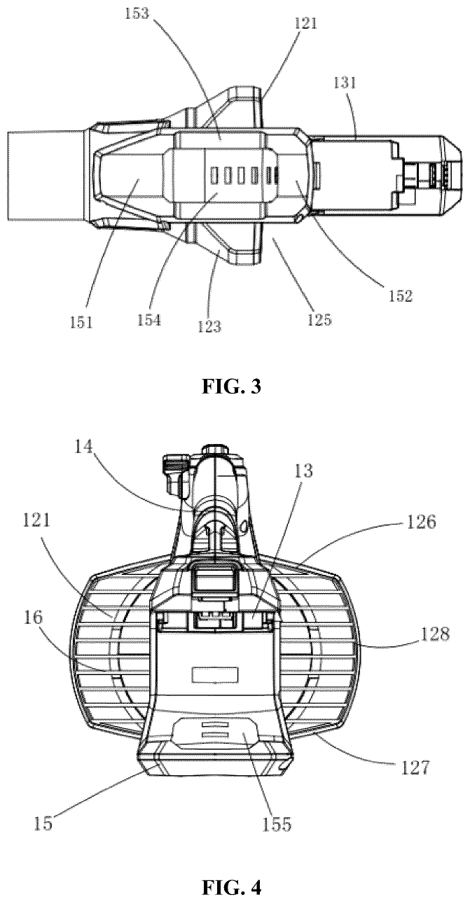

The mounting portion 13 is connected to the axially rear end of the main body portion 12. The main body portion 12 includes a bearing wall 122 located at the axially rear end, an expansion wall 123 connecting the connection portion 11 to the air inlet 121, and an extension wall 124 connecting the air inlet 121 to the bearing wall 122. In a transverse direction perpendicular to the axial direction, a dimension of the expansion wall 123 is larger than that of the extension wall 124, and the air inlet 121 is arranged on an axially protruding region of the expansion wall 123 that protrudes transversely from the extension wall 124. Further, the extension wall 124 extends axially forward from the bearing wall 122 and is recessed transversely inward to form an axial spacing between the air inlet 121 and the bearing wall 122. The axial spacing forms a pre-intake region 125. As shown in FIG. 3 and FIG. 4, the air inlet 121 and the pre-intake region 125 are located between the mounting portion 13 and the connection portion 11 in the axial direction, and on two sides of the mounting portion 13 in the transverse direction. The pre-intake region 125 is located on the axially rear side of the air inlet 121. Such configuration allows external airflow to enter the pre-intake region 125 before entering the main body portion 12, and to form a substantially axial airflow under the guidance of the extension wall 124. The axial airflow entering the main body portion 12 does not lose part of the airflow due to excessive flow direction or turbulence, thereby improving air intake efficiency. A projection of the air inlet 121 along the vertical direction at least partially overlaps with a projection of the handle portion 14 along the vertical direction, and a projection of the air inlet 121 along the axial direction at least partially overlaps with a projection of the battery pack along the axial direction.

As shown in FIG. 4, the expansion wall 123 is configured to extend outward from two transverse sides of the main body portion 12, and includes a first diameter expansion section 126 extending transversely outward from the top of the main body portion 12, a second diameter expansion section 127 extending transversely outward from the bottom of the main body portion 12, and an arc section 128 connected between the first diameter expansion section 126 and the second diameter expansion section 127. When viewed along the axial direction from rear to front, the sum of radian of the expansion wall 123 on two sides of the main body portion 12 on the circumference is greater than or equal to 90°. Through multiple tests, it has been found that when a ratio of the maximum transverse dimension of the air inlet 121 to the maximum transverse dimension of the main body portion 12 (the arc section 128 of the expansion wall 123) is greater than or equal to 0.1, the air intake efficiency can meet the needs of most work scenarios in the market.

The blower 100 further includes multiple flow guide portions 16 spaced apart at the air inlet 121. The flow guide portions 16 are spaced apart to prevent foreign objects from entering the housing 10 and from causing damage to the drive assembly 20. The extension direction of the flow guide portions 16 is parallel to the axial direction, so that the airflow passing through the pre-intake region 125 is approximate to an axial airflow under guidance of the flow guide portions 16, avoiding the airflow from colliding with the inner side of the expansion wall 123 and from causing loud noise after entering. The flow guide portions 16 are integrally formed with the main body portion 12, so that there is no need to additionally install an air guide cover, further reducing mold costs, material costs, and assembly costs. An extension direction of the flow guide portions 16 is substantially parallel to an insertion/removal direction of the battery pack. The airflow entering the housing 10 at least partially flows through the outer surface of the battery pack to enter the pre-intake region 125. Under the guidance of the extension wall 124, the airflow enters the space defined by the expansion wall 123 through the gaps among the flow guide portions 16. The substantial parallelism mentioned herein does not specifically refer to a strictly parallel situation, but may also cover the situations where there is a certain degree of deviation or inclination between the two.

The bearing wall 122 includes a first sidewall 129 facing the handle portion 14 and a second sidewall 120 facing the battery pack. In the vertical direction, the first sidewall 129 and the second sidewall 120 are located on opposite sides of the mounting portion 13. The second sidewall 120 extends vertically along the bottom side of the mounting portion 13 and is substantially perpendicular to the mounting portion 13. The first sidewall 129 extends forward and upward from the top of the mounting portion 13 to the front end of the handle portion 14. The air inlet 121 is located substantially at the intersection of the first sidewall 129 and the front end of the handle portion 14 in the axial direction. In the transverse direction, the pre-intake region is located on two sides of the first sidewall 129. An obtuse angle is formed between the first sidewall 129 and the top surface of the mounting portion 13 to increase the holding space.

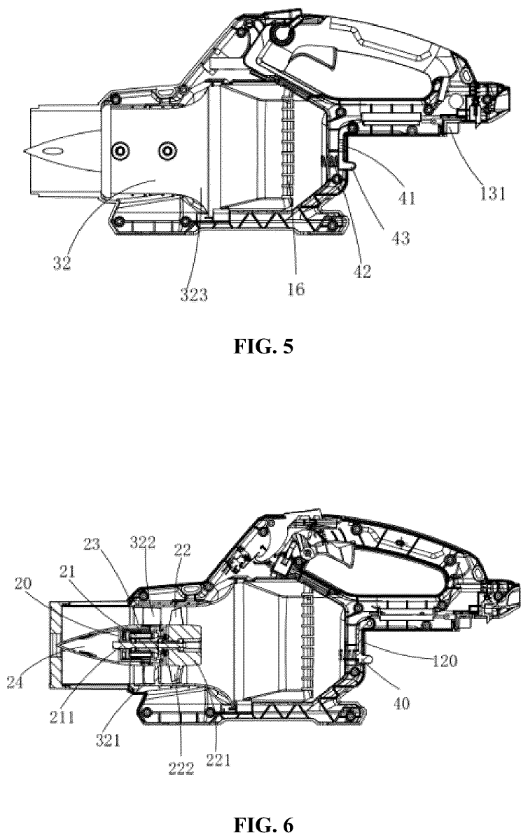

Referring to FIGS. 5 and 6, the mounting portion 13 extends axially rearward from the top of the second sidewall 120, and a guide rail 131 is formed on the lower surface of the mounting portion 13 for guiding the installation or removal of the battery pack. The second sidewall 120 is provided with an ejection mechanism 40 for the battery pack. As shown in FIG. 6, the ejection mechanism 40 includes a rotating rod 41 pivotally fixed to the second sidewall 120 and an elastic member 42 retractably fixed within the second sidewall 120. A protrusion 43 protruding from the second sidewall 120 is arranged at a tail end of the rotating rod 41. The elastic member 42 abuts against the rotating rod 41 such that the protrusion 43 maintains a tendency to protrude from the second sidewall 120. When the battery pack is unlocked, the protrusion 43 presses against the battery pack to eject the battery pack axially from the mounting portion 13.

As shown in FIG. 2, the rear end of the air inlet pipe 32 abuts against the inner side of the extension wall 123. The rear end of the air inlet pipe 32 is provided with a flow-converging portion 323 configured as a tapered ring whose diameter gradually decreases from rear to front along the axial direction. Such configuration ensures that airflow from the main body portion 12 is effectively guided into the air inlet pipe 32 before flowing through the drive assembly 20. The air inlet 121 is axially located between the flow-converging portion 323 and the second sidewall 120, allowing the airflow entering the main body portion 12 to develop a laminar axial flow over a sufficient distance. Such configuration minimizes turbulence-induced impacts on the inner side of the main body portion 12, thereby reducing noise and improving air intake efficiency.

As shown in FIGS. 3 and 4, the support portion 15 includes: a front section 151 connected to the axially front end of the main body portion 12, a rear section 152 connected to the bottom of the second sidewall 120, an intermediate section 153 connecting the front section 151 and the rear section 152. The intermediate section 153 is provided with an intermediate slot 154, and the extension wall 123 of the main body portion 12 is correspondingly provided with multiple spaced air inlet holes aligned with the intermediate slot 154. The rear section 152 is provided with a notch 155, and the main body portion 12 is likewise provided with multiple spaced air inlet holes aligned with the notch 155. Provision of these spaced air inlet holes on the bottom and the rear section of the main body portion 12 can increase the air intake area and improve the air intake efficiency.

In this embodiment, the expansion wall 123 and the extension wall 124 are of a substantially closed structure in the transverse direction, and the bearing wall 122 is also of a substantially closed structure in the axial direction. The “substantially closed structure” herein refers to structures that may either be fully closed (no fluid communication with the outside) or incorporate minimal apertures to permit limited airflow between the interior and exterior of the housing 10.

In the above embodiment, the battery pack is installed axially on the rear side of the second sidewall 120 of the bearing wall 122. In some embodiments, the mounting portion 13 may extend from the first sidewall 129 of the bearing wall 122 toward either the exterior or interior of the housing 10, allowing the battery pack to partially overlap with the main body portion 12 in the vertical direction while retaining other structures (e.g., the air inlet 121 is still arranged on two transverse sides of the mounting portion 13). Such configuration reduces the axial dimension of the whole machine without compromising air intake efficiency or cost. The battery pack may be inserted/removed along the vertical direction or an inclined direction intersecting the axial direction.

The present disclosure is not limited to the specific embodiments described above. Those skilled in the art will readily appreciate that there are many alternatives to the blower of the present disclosure without departing from its principles and scope. The scope of protection of the present disclosure is defined by the appended claims.

What is claimed is:

1. A blower, comprising:
a housing extending along an axial direction;
a battery pack detachably connected to the housing;
a drive assembly at least partially housed within the housing; and
a blow pipe assembly connected to the housing,
wherein the housing comprises a connection portion connected to the blow pipe assembly, a main body portion connected to a rear end the connection portion, and a mounting portion connected to the main body portion, and wherein the drive assembly comprises a motor and a fan driven by the motor to generate airflow flowing through the blow pipe assembly; wherein the main body portion comprises an air inlet and a pre-intake region located axially behind the air inlet, wherein the pre-intake region is located on two sides of the mounting portion in a transverse direction perpendicular to the axial direction.

2. The blower according to claim 1, wherein the air inlet and the pre-intake region are axially located between the mounting portion and the connection portion.

3. The blower according to claim 2, wherein the main body portion comprises a bearing wall located at the rear end thereof and connected to the mounting portion, wherein the air inlet is configured to open axially rearward, and an axial spacing between the bearing wall and the air inlet forms the pre-intake region.

4. The blower according to claim 3, wherein the main body portion comprises an expansion wall connecting the connection portion to the air inlet and an extension wall connecting the air inlet to the bearing wall, wherein a transverse dimension of the expansion wall is larger than a transverse dimension of the extension wall, the air inlet is arranged on a protruding region of the expansion wall that protrudes transversely from the extension wall, and the extension wall is configured to extend axially forward from the bearing wall and is recessed transversely inward to form the pre-intake region.

5. The blower according to claim 4, wherein the expansion wall and the extension wall are of a substantially closed structure in the transverse direction.

6. The blower according to claim 1, wherein the blower comprises a plurality of flow guide portions spaced apart at the air inlet, wherein an extension direction of the plurality of flow guide portions is substantially parallel to an insertion/removal direction of the battery pack.

7. The blower according to claim 6, wherein the plurality of flow guide portions are integrally formed with the main body portion.

8. The blower according to claim 1, wherein a ratio of a maximum transverse dimension of the air inlet to a maximum transverse dimension of the main body portion is greater than or equal to 0.1.

9. The blower according to claim 1, wherein the housing comprises a handle portion connecting the main body portion to the mounting portion, wherein a bearing wall connected to the mounting portion is provided at the axially rear end of the main body portion, and comprises a first sidewall facing the handle portion and a second sidewall facing the battery pack, wherein the first sidewall and the second sidewall are located on opposite sides of the mounting portion in a vertical direction perpendicular to the axial direction and the transverse direction.

10. The blower according to claim 9, wherein a projection of the air inlet along the vertical direction at least partially overlaps with a projection of the handle portion along the vertical direction, and a projection of the air inlet along the axial direction at least partially overlaps with a projection of the battery pack along the axial direction.

11. A blower, comprising:
a housing extending along an axial direction, the housing comprising a main body portion and a mounting portion connected to an axially rear end of the main body portion;
a battery pack, detachably connected to the mounting portion;
a motor, at least partially housed within the main body portion; and
a fan, driven by the motor to rotate to generate airflow;
wherein the blower comprises a pre-intake region and an air inlet axially communicating interior and exterior of the housing, wherein the main body portion has a front edge and a rear edge in the axial direction, and the air inlet is axially positioned between the front edge and the rear edge and is spaced apart from the rear edge by a predetermined axial distance, and the predetermined axial distance is configured to form the pre-intake region.

12. The blower according to claim 11, wherein the main body portion comprises an expansion wall, a bearing wall connected to the mounting portion, and an extension wall connecting the expansion wall with the bearing wall, wherein a transverse dimension of the expansion wall is larger than a transverse dimension of the extension wall, and the air inlet is arranged on a protruding region of the expansion wall that protrudes laterally from the extension wall.

13. The blower according to claim 12, wherein the bearing wall constitutes the rear edge, wherein the extension wall extends axially forward from the bearing wall and is laterally indented to form the pre-intake region, wherein the pre-intake region is positioned between the air inlet and the mounting portion.

14. The blower according to claim 13, wherein the expansion wall and the extension wall form an enclosed structure in a transverse direction, wherein the expansion wall, the air inlet, and the extension wall together form the pre-intake region.

15. The blower according to claim 11, wherein the housing comprises a handle portion connected to the main body portion, wherein the handle portion comprises a first end and a second end spaced apart in the axial direction, wherein the air inlet is axially positioned between the first end and the second end in the axial direction.

16. The blower according to claim 15, wherein the air inlet comprises a first air inlet positioned on one side of the handle portion and a second air inlet positioned on another side of the handle portion, wherein an axial distance between the first air inlet and the rear edge forms a first pre-intake region, and an axial distance between the second air inlet and the rear edge forms a second pre-intake region, wherein the first pre-intake region and the second pre-intake region are formed as open spaces without any physical barriers between the air inlet and the rear edge.

17. The blower according to claim 16, wherein when the battery pack is connected to the mounting portion, wherein an axial projection of the air inlet at least partially overlaps with an axial projection of the battery pack.

18. The blower according to claim 11, wherein a ratio of a maximum transverse dimension of the air inlet to a maximum transverse dimension of the main body portion is greater than or equal to 0.1.

19. A blower, comprising:
a housing extending along an axial direction, the housing comprising a connection portion, a main body portion connected to an axially rear side of the connection portion, and a mounting portion connected to a rear side of the main body portion;
a battery pack detachably connected to the mounting portion;
a blow pipe assembly connected to the connection portion;
a handle portion connected to the housing; and
a drive assembly at least partially housed in the main body portion, the drive assembly comprising a motor and a fan driven by the motor to rotate to generate airflow flowing through the blow pipe assembly;
wherein the main body portion comprises a first air inlet and a second air inlet respectively located on opposite sides of the handle portion, wherein the first and second air inlets are open axially rearward, an axial distance between the first air inlet and the mounting portion forms a first pre-intake region, and an axial distance between the second air inlet and the mounting portion forms a second pre-intake region, wherein the first pre-intake region and the second pre-intake region are formed as open spaces without any physical barriers between the air inlet and the mounting portion.

20. The blower according to claim 19, wherein a transverse dimension of the main body is larger than a transverse dimension of the mounting portion, and the first pre-intake region and the second pre-intake region are formed between the mounting portion and a protruding region of the main body that protrudes laterally from the mounting portion.
